(19) United States
(12) Patent Application Publication
(10) Pub. No.: US 2026/0271160 A1
(43) Pub. Date: Sep. 10, 2026

(54) CONTROL DEVICE FOR RENDERINGDOWNSIZED LIGHTING-EFFECT ROUTINE

(71) Applicant: SIGNIFY HOLDING B.V., EINDHOVEN (NL)

(72) Inventors: TOBIAS BORRA, RIJSWIJK (NL); FETZE PIJLMAN, EINDHOVEN (NL)

(21) Appl. No.: 19/166,585

(22) PCT Filed: Mar. 19, 2024
(86) PCT No.: PCT/EP2024/057232

§ 371 Date: Sep. 18, 2025

(30) Foreign Application Priority Data
Mar. 24, 2023 (EP) 23164170.5

(51) Int. Cl. H05B 47/155

(52) U.S. Cl. CPC H05B 47/155

(57) ABSTRACT

The invention is directed to a control device (100) for controlling target lighting devices (TD1, TD2) for rendering a downsized lighting-effect routine (102) intended to be rendered by a larger number of devices. A data ascertainment unit (106) is configured to ascertain lightscript data (108) indicative of a set of intended light settings comprising light effects. A processing unit (110) is configured to select a number of surplus light settings, to distribute the light effects of the surplus light settings to the other intended light settings and generate a downsized set of light settings (S4, S5) indicative thereof; and to generate and provide control signals (112) for controlling the target lighting devices (TD1, TD2) in accordance with the downsized set of light settings (S4, S5), and thereby improving the fidelity with respect to the intended routine.

### FIELD OF THE INVENTION

The invention is directed to a control device for controlling one or more target lighting devices of a target lighting arrangement for rendering a downsized lighting-effect routine that corresponds to an intended lighting-effect routine that is intended to be rendered by at least a predetermined number of intended lighting devices that is higher than a number of target lighting devices of the target lighting arrangement. The invention is further directed to a target lighting arrangement, to a respective computer implemented method for controlling operation of the control device and of the target lighting arrangement and to a computer program.

### BACKGROUND OF THE INVENTION

In 2021 Hue Spotify was introduced, allowing for the creation of light effects based on Spotify metadata. Here, an algorithm analyses the metadata for every song a user is playing and generates a lighting-effect routine that includes light effects to be rendered on a connected lighting arrangement accordingly. Philips Hue generates lightscripts to reflect the beat of the music and are tuned to each song, matching the genre, mood and metre. Inherent to current versions of the algorithm is that they are optimized to run on a plurality of lights, with an optimal experience reached for a preferred 6 lights. When more lights are included, light effects assigned to one or more lighting device are ‘copied’ to the other lighting devices. However, when less lighting devices are included in an entertainment zone, the lightscript generated by the algorithm is ‘clipped’ meaning that even though the lightscript is intended for 6 lighting devices, the surplus of light effects are simply left out. This further implies that special light effects that are to be rendered on e.g. intended lighting devices number 5 and 6 are not rendered in an entertainment setup of 4 lighting devices, resulting in a possible degradation of the overall experience. This degradation may be due to the fact that the overall dynamics of the lightscript are changed, simply because less light effects are being rendered. This may result in a potential mismatch in the salient events detected by a user in the audio (e.g. a vocalist starting, a snare drum kicking in, etc.) which is then not rendered on the lighting devices in the entertainment zone.

Document WO 2020/249502 described a computer implemented method for controlling a plurality of lighting devices of a lighting arrangement that includes obtaining a set of lighting settings, analyzing said set of lighting settings to extract one or more features of the light settings, that relate to light characteristics, receiving one or more signals indicative of the number of lighting devices, determining a number of clusters based on the number of lighting devices, clustering the set of light settings into the determined number of clusters based on the extracted one or more features, determining respective lighting control setting for respective clusters, associating the respective clusters with a respective lighting device and controlling the plurality of lighting devices according to the respective lighting control settings of the respective associated clusters.

### SUMMARY OF THE INVENTION

It would be beneficial to provide an alternative for rendering lighting-effect routines on a target lighting arrangement having less target lighting devices than those originally intended for the lighting-effect routine that has a higher degree of fidelity with respect to the original light effects of the lighting-effect routine, and also that is simpler to implement.

According to a first aspect of the present invention a control device according to claim 1 is disclosed. The control device is configured to control one or more target lighting devices of a target lighting arrangement for rendering a downsized lighting-effect routine that corresponds to an intended lighting-effect routine intended to be rendered by at least a predetermined number of intended lighting devices that is higher than a number of target lighting devices of the target lighting arrangement. The lighting-effect routine provided, referred to as intended lighting-effect routine, is designed to be rendered by at least a predetermined number of lighting devices, referred to as intended lighting devices, which may correspond to a number of channels included in the lightscript data. This number may be larger than the current number of available lighting devices, referred to as target lighting devices, of the target lighting arrangement that is going to render the lighting-effect routing. Therefore, if this case, a downsized lighting-effect routing has to be determined, which corresponds to the intended lighting-effect routine and which is to be rendered by the target lighting devices of the target lighting arrangement. The control device of the first aspect of the invention comprises a data ascertainment unit that is configured to ascertain, e.g. to receive or to determine, lightscript data indicative of a set of intended light settings, each intended light setting comprising one or more light effects associated to a respective intended lighting device. The set of intended light settings is indicative, or in other words, represents, the intended lighting-effect routine. The control device also comprises a processing unit that is connected to the data ascertainment unit and is configured to select, in accordance with a predetermined selection algorithm or selection rule, a number of surplus light settings that corresponds to a difference between the number of intended lighting devices for rendering the intended lighting-effect routine and the number of target lighting devices of the target lighting arrangement, to associate, in accordance with a predetermined association rule or association algorithm, the light effects of the selected surplus light settings to the light settings of those remaining intended light settings that are not surplus light settings and generate a downsized set of light settings indicative thereof, and also to generate and provide control signals for controlling the target lighting devices in accordance with the downsized set of light settings for rendering the downsized lighting-effect routine on the target lighting arrangement.

Thus, the processing unit first determines the offset or difference between the number of intended lighting devices expected to render intended lighting-effect routine as specified by the ascertained lightscript data, and the number of target lighting devices available at the target lighting arrangement. If the difference is zero, the intended lighting-effect routine is rendered as expected, associating each of the intended light settings to a respective one of the target lighting device. If there are more target lighting devices than intended or required by the lightscript data, some of the intended light settings can be rendered simultaneously by more than one target lighting device. However, in the case that the number of available target devices is smaller than the number of intended lighting devices originally required (as specified by the lightscript data) to render the intended lighting-effect routine, instead of ignoring those light effect associated to an intended lighting device that does not have counterpart in the target lighting arrangement, the processing unit, using a predetermined selection algorithm, to select which of the intended light setting will be considered as surplus light settings. The processing unit is then configured to generate a downsized set of light settings indicative of, or representing, a downsized lighting effect routine that can be rendered by the target lighting arrangement, and which, instead of ignoring the light effects of those intended lighting devices or, in other words, those channels of the lightscript, that do not find a rendering counterpart among the target lighting devices, integrates the surplus light effect into the remaining (non-surplus) light effects. Therefore, the processing unit is configured, in accordance with a predetermined association rule, to associate the light effects of the selected surplus light settings to the light settings of those remaining intended light settings (i.e. those that are not surplus light settings and generate a downsized set of light settings indicative of said association. Thus, the processing unit is configured to integrate the light effects of the surplus light settings to the light settings that are not surplus settings and which have therefore a rendering counterpart amount the target lighting devices, in accordance with a predetermined association rule.

The processing unit is then configured to generate and provide the necessary control signals for controlling the target lighting devices according to the generated downsized set of light settings. The control signals comprise therefore operation instructions to operate the lighting devices such that the light output of the lighting devices follows the downsized set of light settings. This enables rendering the downsized lighting-effect routine on the target lighting arrangement with a higher fidelity or degree of similarity with the originally intended lighting-effect routine as current solutions.

In the following, embodiments of the control device of the first aspect of the invention will be described.

The light setting refers to series of one or more light effects that are to be rendered by a lighting device. The lighting devices are devices that output light in a controllable manner, and have variable and controllable operation points, for instance in terms of brightness, color, temperature, position, beam angle, beam orientation etc., which are referred to as lighting parameters. A light effect corresponds to a given operation point in which the lighting device is to be operated and the light setting corresponds to the variation in time of the operation point for a given lighting device, e.g., an intended lighting device (or lightscript channel) or a target lighting device. The downsized set of light settings includes, for each of the target lighting device, a list of one or more light effects that have the respective target lighting device has to produce in order for the target lighting arrangement to render the downsized lighting-effect routine.

In a preferred embodiment, the lightscript data comprises priority data indicative of a respective priority of the intended light settings of the set of intended light settings, and wherein the processing unit is configured to select the surplus light settings in dependence on the priority data. Thus, the predetermined selection algorithm makes use of the priority data to select those lighting settings that will be considered surplus lighting settings, in particular those intended lighting settings associated with priority data indicating a lower priority. Preferably, for a given number of target lighting devices N and intended lighting devices (or lightscript data channels) M, the N intended light settings having the highest priority according to the priority data will not be selected as surplus lighting effects. The processing unit is then configured to associate, or integrate, the light effects of the remaining (M-N) intended light settings, i.e., the surplus light settings, into the first N light settings in accordance with the predetermined association rule.

In another embodiment, the predetermined selection algorithm is based on a number or rate of light effects or light effect changes for a given light setting, where a larger number or rate may denote a higher importance in the overall lighting effect routine.

In another embodiment, the intended light settings included in the lightscript data comprise, or are divided into, leading light settings and support light settings. In this embodiment, the processing unit is configured, upon determination that the number of leading light settings is smaller than the number of target lighting devices, to assign each leading light settings to a respective one of the target lighting devices, to combine the light effects of the support light settings according to a predetermined combination rule to generate downsized support light settings, and to generate and provide control signals for controlling the target lighting devices in accordance with the leading light settings and the downsized support light settings for rendering the downsized lighting-effect routine on the target lighting arrangement. Thus, the intended light settings in the lightscript are divided into a “leading part” and a “supportive part” (just like in music). A given lightscript expected to be rendered over e. g. 6 channels can be optimally reduced by redistributing merging channels that are of a supportive nature. Thus, the processing unit selects, if possible, the support light settings as surplus light settings. In case that the “lead” channels (leading light settings) equal the number of physical channels (target lighting devices), or in other words, when there are no target lighting devices for supportive channels, i.e. the support light settings, the supportive channels can be mixed on the physical channels. Per physical channel (i.e., target lighting device) the mixing can be achieved by weighing the inputs e.g. light effects, with their brightness. If there is one or more target lighting devices still available for the support light settings, the light effects of the support light settings can be integrated or combined or assigned to the available target lighting device.

In another embodiment, the processing unit is further configured to determine parameter data indicative of one or more lighting parameters of the light effects and to associate the light effects of the surplus intended light settings further in dependence on the extracted parameter data. For instance, the lighting parameters for which parameter data is determined may include one or more of color value, brightness value, beam-shape, angle value, orientation or position. For a redistribution of light effects, the primary determining factor preferably resides in the brightness of an effect, since this can be superposed on an existing lighting device, without e.g., color artefacts. When a lightscript is reduced from e.g. two intended lighting devices or lightscript channels to one target lighting device, and according to the intended lighting-effect routine intended lighting device A displays a red flash at 1 second, and intended lighting device B displays a blue flash at 2 seconds, then the redistributed script, i.e. the downsized set of light settings for one target lighting device may be generated such that the target lighting device shows the light as a red flash at second 1 (taken from intended lighting device, or lightscript channel, A) and another red flash at second 2 (where only the intensity is taken from intended lighting device B, but not the color). Alternatively, both parameters can be taken into account to be redistributed, based on e.g. effects density and number of available target lighting devices.

In another embodiment the data ascertainment unit is further configured to ascertain lighting device data indicative of respective operational capabilities of the target lighting devices, and wherein the processing unit is further configured to associate the light effects of the surplus intended light settings further in dependence on the ascertained lighting device data. For example the lighting device data can be indicative of a range of color values of the light that can be provided by a given lighting device, or a range of brightness values, a range of temperature values, a range of angle-beam values, a range of directivity (e.g. how focused can the light beam be provided) values, etc. The association rule preferably takes into account the operational capabilities of the target lighting devices, and preferably also the parameter data of the lights effect to associate or distribute the surplus light effects among the target lighting devices, such that the lighting parameters (brightness value, color value, temperature value, beam direction, etc.) can be output by a suitable target lighting devices capable of outputting said lighting parameters.

Preferably, in an embodiment according to the first aspect of the invention, the data ascertainment unit is configured as a data input unit that is configured to receive the lightscript data via a wired or a wireless connection. Alternatively the data ascertainment unit is configured as a lightscript data generating unit, which generates lightscript data based on a media file, such as a video file, an audio file, an image file, etc.

A second aspect of the present invention is formed by a target lighting arrangement for rendering a downsized lighting-effect routine as described above. The lighting arrangement comprises one or more target lighting devices, which are lighting devices whose operational state can be controlled in order to render light effects. The target lighting arrangement further comprises a control device in accordance with the first aspect of the invention, and which is configured to control the one or more target lighting devices for rendering a downsized lighting-effect routine that corresponds to an intended lighting-effect routine intended to be rendered by at least a predetermined number of intended lighting devices that is higher than a number of target lighting devices of the target lighting arrangement.

The arrangement of the second aspect of the present invention shares the advantages of the control device of the first aspect of the invention.

In an embodiment, the target lighting arrangement is a wirelessly controllable lighting arrangement that is controlled by means of communication signals provided via a suitable wireless communication network, such as WiFi, Bluetooth, BLE, Thread, 3G, 4G, 5G, etc. Additionally, or alternatively, at least a subset of the lighting devices of the arrangement can be controlled via a wired connection, for instance via a wired DALI (Digital Addressable Lighting Interface) connection.

The control unit can be integrated in a hub, bridge or other network control device of the lighting arrangement. Alternatively the control unit can be a remote device configured to send the downsized set of light settings that is indicative of the downsized lighting-effect routine to a hub or a bridge or a suitable network control device of the target lighting arrangement.

A third aspect of the present invention is formed by a computer implemented method for controlling operation of a controller device in accordance with the first aspect of the present invention. The method comprises:
ascertaining, e.g. receiving or determining, lightscript data indicative of a set of intended light settings, each intended light setting comprising one or more light effects associated to a respective intended lighting device, the set of intended light settings being indicative of an intended lighting-effect routine;
selecting, in accordance with a predetermined selection algorithm, a number of surplus light settings that corresponds to a difference between the number of intended lighting devices for rendering the intended lighting-effect routine and a number of target lighting devices of a target lighting arrangement;
associating, in accordance with a predetermined association rule, the light effects of the selected surplus light settings to the light settings of those remaining intended light settings that are not surplus light settings and generating a downsized set of light settings indicative thereof; and
generating and providing control signals for controlling the target lighting devices in accordance with the downsized set of light settings for rendering the downsized lighting-effect routine on the target lighting arrangement.

Thus, the method of the third aspect of the invention shares the advantages of the control device in accordance with the first aspect of the invention.

In the following, embodiments of the inventive method of the third aspect will be described.

In an embodiment, the method further comprises:
selecting the surplus light settings in dependence on priority data comprised by the lightscript data.

In yet another embodiment, the method additionally or alternatively comprises determining parameter data indicative of one or more lighting parameters (e.g. brightness, temperature, color, orientation, beam-angle, etc.) of the light effects and to associating the light effects of the surplus intended light settings further in dependence on the extracted parameter data.

In yet another embodiment, the method further comprises ascertaining lighting device data indicative of respective operational capabilities of the target lighting devices, and associating the light effects of the surplus intended light settings further in dependence on the ascertained lighting device data.

In another particular embodiment wherein the intended light settings included in the lightscript data comprise leading light settings and support light settings, the method further comprises, upon determining that the number of leading light settings is smaller than the number of target lighting devices,
assigning each leading light settings to a respective one of the target lighting devices;
combining the light effects of the support light settings according to a predetermined combination rule to generate downsized support light settings; and
generating and providing control signals for controlling the target lighting devices in accordance with the leading light settings and the downsized support light settings for rendering the downsized lighting-effect routine on the target lighting arrangement.

A fourth aspect of the invention is formed by a method for controlling operation of a target lighting arrangement, for rendering a downsized lighting-effect routine that corresponds to an intended lighting-effect routine to intended to be rendered by at least a predetermined number of intended lighting devices that is higher than a number of target lighting devices of the target lighting arrangement. The method comprises:
performing the method of the third aspect of the invention; and
controlling the target lighting devices of the target lighting arrangement in accordance with the downsized lighting-effect routine.

A fifth aspect of the invention is formed by a computer program product comprising instructions, which, when executed by a control device, cause the control device to carry out the method of the third aspect and/or the method of the fourth aspect of the present invention.

It shall be understood that the control device of claim 1, the target lighting arrangement of claim 8, the computer implemented method for controlling operation of a controller device of claim 9, the computer implemented method for controlling operation of a target lighting arrangement of claim 14, and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic block diagram of a target lighting arrangement,

FIG. 2 shows a flow diagram of a computer implemented method 200a for controlling operation of a target lighting arrangement that includes a computer implemented method 300 for controlling operation of a controller device, and

FIG. 3 shows a flow diagram of a computer implemented method 200b for controlling operation of a target lighting arrangement that includes a computer implemented method 400 for controlling operation of a controller device.

### DETAILED DESCRIPTION OF EMBODIMENTS

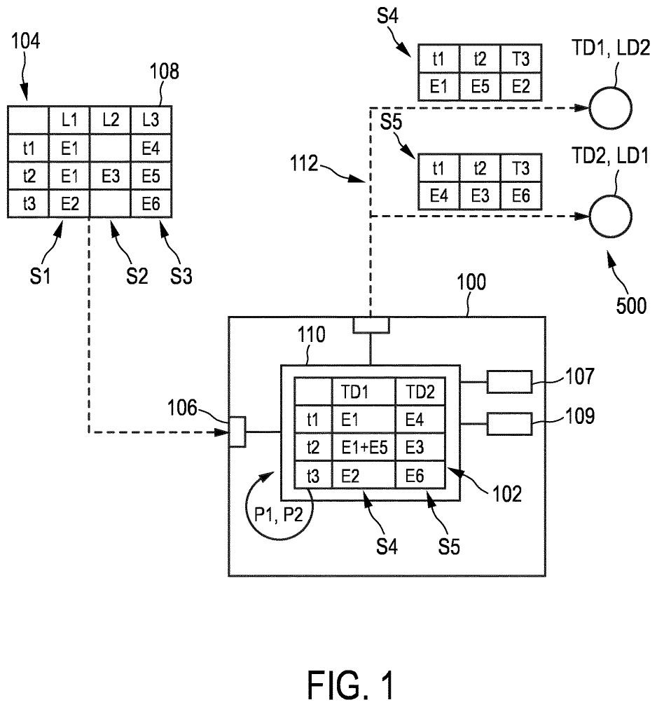

FIG. 1 shows a schematic block diagram of a target lighting arrangement 500 in accordance with an embodiment of the invention. The target lighting arrangement 500 exemplarily comprises two target lighting devices TD1, TD2. The target lighting devices are, for instance, wirelessly controllable lighting devices that be include light-strips, spot lights, wall lights, ceiling lights, pendant lights, track lights, table lights, floor lamps, recessed lights, or outdoor lights, which are capable of varying the values of one or more lighting parameters including brightness, temperature, color, orientation, beam angle, etc.

The target lighting arrangement also comprises a control device 100, in this particular example in the form of a network control unit, such as a hub or a bridge. The target lighting arrangement can be implemented as a Hue lighting arrangement, where the control device 100 is a Hue bridge.

The control device is configured to control the target lighting devices T1, T2 of the target lighting arrangement 500 for rendering a downsized lighting-effect routine 102. The downsized lighting-effect routine corresponds to an intended lighting-effect routine that is originally intended to be rendered by at least a predetermined number of intended lighting devices L1, L2, L3. The number of intended lighting devices is in this case is higher than a number of target lighting devices TD1, TD2. In known arrangements (not shown), under this circumstances, part of the intended lighting-effect routine is ignored and not rendered by the lighting devices of the lighting arrangement.

The control device 100 comprises a data ascertainment unit 106, here shown as an input unit that is configured to receive lightscript data 108. The lightscript data 108 is indicative of a set of intended light settings S1, S2, S3, each intended light setting or channel comprising one or more light effects E1, E2, E3, E4, E5, E6 that are associated to a respective intended lighting device L1, L2, L3 or lightscript channel. The set of intended light settings is indicative or characterizes the intended lighting-effect routine 104. The lightscript data can be for instance provided by Hue-Spotify, allowing for the creation and rendition of light effects based on media-based, e.g., Spotify, metadata. A user may define some of the characteristics of the intended lighting-effect routine, such as a preferred color palette, a maximum brightness value, a preferred variation rate of the light-effects, a routine style (e.g., pulses, color transitions, etc.). An algorithm analyses the metadata for an audio file that a user is playing and generates a lighting-effect routine that includes light effects to be rendered on a connected target lighting arrangement accordingly. According to the exemplary lightscript data 108, the intended lighting-effect routing 104 has three channels, each associated to a respective intended lighting device L1, L2, L3. During a first timespan t1, the intended light setting S1, that is associated to intended lighting device L1, includes a first light effect E1 (e.g. a combination of predetermined values of one or more lighting parameters such as, color and brightness). The second intended light setting S2, which is associated to intended lighting device L2 remains idle during said first time span (e.g. the intended lighting device does not output any light), and the third intended light setting S3, associated to an intended lighting device L3, includes a light effect E4. During a second timespan t2 the intended light setting S1 keeps including the same light effect as in the first timespan t1, whereas the second intended light setting S2, which implied an idle device in t1, now includes a light effect E3, for example a bright red flash with a given duration. Also during t2 the third intended light setting changes from light effect E4 to light effect E5. During a third timespan t2, the first intended light setting changes the light effect from E1 to E2, the second intended light setting becomes idle again and the third intended light setting changes from light effect E5 to light effect E6.

For target lighting arrangements with a number of target lighting devices equal to the number of intended lighting devices, each of the target lighting devices could be instructed to render a respective one of the intended light settings. If there are more target lighting devices than intended lighting devices, two or more target lighting devices may be instructed to render the same intended light settings. For example, if the intended lighting-effect routine 104 were to be rendered by a lighting arrangement including four target lighting devices, a first and a second device could be instructed to render the first intended light setting S1, a third device could be instructed to render the second intended light setting S2 and a fourth device could be instructed to render the third intended light setting.

However, according to FIG. 1, the target lighting arrangement only has two target lighting, a number smaller than the number of intended lighting devices L1, L2, L3 or number of intended light settings S1, S2, S3. In this case, known arrangements would for instance render the first intended light setting S1 using target lighting device TD1 and the second intended light setting S2 using the second target lighting device TD2, while not rendering the third intended light setting S3 at all. In order to provide a lighting-effect routine 102 with a higher degree of similarity with respect to the intended lighting-effect routine 104, the control device 100 comprises a processing unit 110 that is connected to the data ascertainment unit 106 and configured to select, in accordance with a predetermined selection algorithm 107, a number of surplus light settings S3 that corresponds to a difference between the number of intended lighting devices L1, L2, L3 for rendering the intended lighting-effect routine 104 and the number of target lighting devices TD1, TD2 of the target lighting arrangement 500. In this particular case, the processing unit is configured to select one of the intended light effect settings as a surplus light settings, for example S3. This selection is done in accordance with a predetermined selection algorithm that may be, for instance, based on a numerical ordering of the intended light settings, on a content in terms of light effects of the intended light settings or other consideration. For example, the lightscript data may include priority data indicative of a respective priority of the intended light settings, such that those intended light settings with a lower priority tend to be selected as surplus light settings.

The processing unit is also configured to associate, in accordance with a predetermined association rule 109, the light effects E4, E5, E6 of the selected surplus light settings, in this case S3, to the light settings S1, S2 of those remaining intended light settings that are not surplus light settings, in this case S1, S2. Based on this association, the processing unit is configured to generate a downsized set of light settings S4, S5 indicative of the association. In this example, the light effects E3 and E6 has been associated to intended light setting S2, which was idle during the corresponding timespans t1 and t3. This forms light setting S5 which is part of the downsized set of light settings. The light effect E5 is combined with light effect E1 of intended light setting S1 to form light setting S4, which is also part of the downsized set of light settings. For example, light effect E5 may consist of a sequence of light flashes characterized by a maximum brightness a minimum brightness and a frequency and light effect E1 may consist of a constant brightness and a constant color. The resulting light effect E1+E5 to be rendered at t2 (the times or timespans are typically relative to a duration of the media file, such as the video or audio file) is part of light setting S4. In another example, the light effect E1 corresponds to a first color and the light effect E5 corresponds to a second color and the combination of effects E1+E5 correspond to a combination of both colors (the sum of the RGB components for example). In another example, the light effect E1 corresponds to a certain pattern of light flashes with a first frequency and the light effect E5 corresponds to another pattern of light flashes with a second frequency. Here, the combination of light effects E1 and E5 correspond of a combination of both patterns of light flashes. The association, i.e. which light effects can be combined with each other, is predetermined by the association rule, for instance based on a predetermined list of allowable associations that minimize artifacts in the downsized lighting-effect routine.

For example, according to a suitable association rule, the light effects of the surplus light settings are redistributed or assigned to the light settings to be rendered by the available target lighting devices, ideally with an equal weight for each available target lighting device. In other words, when the original lightscript data involves, e.g., six intended lighting devices, and an actual target lighting arrangement includes only five target lighting devices, then all light effects for the 6th intended lighting device, which are to be redistributed, are equally distributed over the 5 available target lighting devices. Here, the redistribution should ideally be done such that there is no overlap between an existing light effect and the superposed light effect from the surplus light setting. This overlap could be based on a simple timing cut-off, e.g. 500 ms, or on the dynamics of an existing effect. In case of the latter, a brief flash with a fade-out of 2 seconds could be left intact, with the superposed effect rendered on a different target lighting device, or the fade-out could be cut short. According to an exemplary association rule, different light effects, or types of light effects (e.g. brightness changes or flashes, color changes or transitions, etc.) have a predefined priority, such that when associating the light effects of the surplus light settings, those with a highest priority will be assigned first, if allowed by the operational conditions of the target lighting devices. For instance, in examples where an intended lighting-effect routine with six intended light settings is to be rendered by a target lighting arrangement with one single target lighting device, the light effects of the five surplus light settings might not be all assignable to the target lighting device and the processing unit, in accordance with the association rule will start the association with those light effects having a higher priority value.

The processing unit is also configured to generate and provide control signals 112 for controlling the target lighting devices TD1, TD2 in accordance with the downsized set of light settings S4, S5 for rendering the downsized lighting-effect routine 102 on the target lighting arrangement 500. The control signals 112 therefore include instructions that cause the lighting devices to output the light effects comprised in the respective light setting S4 and S5 of the set of downsized light settings S4, S5.

For example, the intended light settings S1, S2, S3 included in the lightscript data 108 may comprise, or be divided into, leading light settings and support light settings. The processing unit 100 can be configured, upon determination that the number of leading light settings is smaller than the number of target lighting devices, to assign each leading light settings to a respective one of the target lighting devices, to combine the light effects of the support light settings according to a predetermined combination rule to generate downsized support light settings and to generate and provide control signals 112 for controlling the target lighting devices TD1, TD2 in accordance with the leading light settings and the downsized support light settings for rendering the downsized lighting-effect routine 102 on the target lighting arrangement 500. Thus, the lightscript is divided into a “leading part” that includes the leading light settings and a “supportive part”, that includes the support light settings. This division is similar to that used in music. A given lightscript over six channels (i.e., for six intended lighting devices) can be optimally reduced by redistributing & merging channels that are of a supportive nature. In case that the “lead” channels equal the number of physical channels, or target lighting devices, (meaning no target lighting devices are available for the supportive channels), the “supportive” channels, or in other words, the light effects associated to the support light settings, can be mixed on the physical channels. Per physical channel (target lighting device) the mixing can be achieved by weighing the inputs with their brightness.

According to other exemplary selection and association rules, the choice for mixing the intended light settings is determined by the order in which they appear. Implicitly, this is equivalent to assuming that the first channels, i.e., the first intended light settings, are of higher importance than the later ones. The last (M-N) intended light settings are selected as surplus light settings and are assigned to an available light setting where preference is given to less important light settings in order not to disturb the more important light settings. The super position of inputs can be achieved by giving priority to the last input change-signal received. For example, Table 1 exemplifies a case where a lightscript for six intended lighting devices (e.g. with six channels) is to be rendered by five target lighting devices. The first four intended light settings are assigned to four corresponding target lighting devices and are not shown in Table 1. Intended light settings 5 and 6 (channels 5 and 6 in Table 1, where the RGB values are given as a function of time) are combined into a mixed channel, forming a downsized light setting, that will be rendered in the remaining target lighting device.

TABLE 1
RGB values as a function of time of two lightscript channels
and the resulting downsized light setting (mixed channel).

| Time (h:min:sec) | Channel 5 | Channel 6 | Mixed channel |
|---|---|---|---|
| 00:00:00 | RGB = [255, 0, 0] | | RGB = [255, 0, 0] |
| 00:00:02 | RGB = [200, 100, 0] | | RGB = [200, 100, 0] |
| 00:00:03 | | RGB = [0, 0, 200] | RGB = [0, 0, 200] |
| 00:00:05 | RGB = [255, 0, 0] | | RGB = [255, 0, 0] |

In an exemplary control device 100 the processing unit is further configured to determine parameter data indicative of one or more lighting parameters P1, P2 of the light effects E1, E2, E3, E4, E5, E6 and to associate the light effects of the surplus intended light settings further in dependence on the extracted parameter data. For instance, the lighting parameters for which parameter data is determined include one or more of color value, brightness value, beam-shape, angle value, orientation or position. Preferably, the primary determining factor should reside in the brightness of a light effect, since this can be superposed on an existing light setting, without weird color artefacts. The processing unit determined parameter data indicative of the brightness and, based thereon, assigns or associates the light effects to generate a downsized set of light setting S4, S5.

Additionally, in an exemplary control device 100, the data ascertainment unit is further configured to ascertain (receive or determine) lighting device data LD1, LD2 that indicative of respective operational capabilities of the target lighting devices TD1, TD2. The respective operational capabilities can determine whether a given lighting device can render a particular light effect or not. For instance, lighting devices where only the brightness value and/or the light temperature can be varied, are not suitable for rendering a light effect involving, for example, a color transition, and therefore, no such light effect should be included in a light setting to be rendered by said lighting device. The processing unit 110 is therefore further configured to associate the light effects of the surplus intended light settings further in dependence on the ascertained lighting device data.

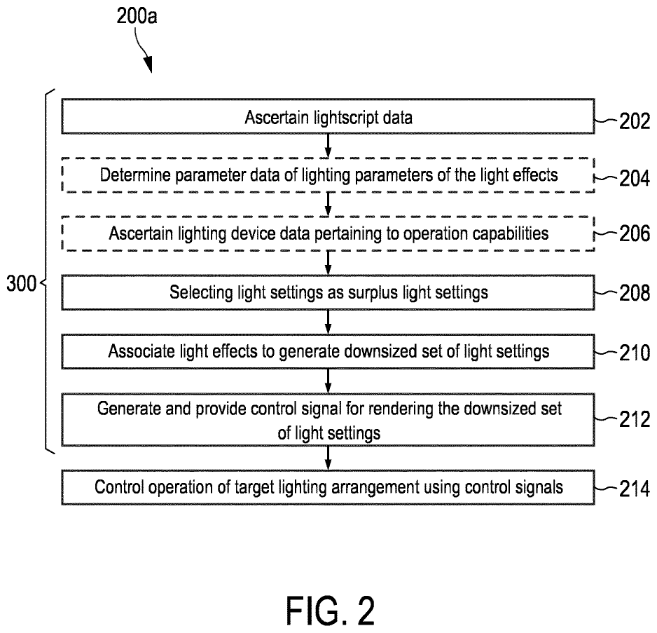

FIG. 2 shows a flow diagram of a computer implemented method 200a for controlling operation of a target lighting arrangement. The method 200a also includes a computer implemented method 300 for controlling operation of a controller device in accordance with an embodiment of the invention. The methods 200a and 300 comprise, in a step 202, ascertaining lightscript data indicative of a set of intended light settings, each intended light setting comprising one or more light effects associated to a respective intended lighting device or lightscript channel, the set of intended light settings being indicative of an intended lighting-effect routine. The methods 200a and 300 also comprise, in a step 208, selecting, in accordance with a predetermined selection algorithm, a number of surplus light settings that corresponds to a difference between the number of intended lighting devices for rendering the intended lighting-effect routine and a number of target lighting devices of a target lighting arrangement. The methods also comprise, in a step 210 associating, in accordance with a predetermined association rule, the light effects of those light settings selected as surplus light settings (i.e. the selected surplus light settings) to the light settings of those remaining intended light settings that have not been selected as surplus light settings and generating a downsized set of light settings indicative of said association. The methods also comprise, in a step 212, generating and providing control signals for controlling the target lighting devices in accordance with the downsized set of light settings for rendering the downsized lighting-effect routine on the target lighting arrangement. The method 200a also comprises, in a step 214, controlling the target lighting devices of the target lighting arrangement in accordance with the downsized lighting-effect routine.

In an exemplary method, the step 208 is performed in dependence on priority data comprised by the lightscript data.

In an embodiment, the methods 200a and 300 may include, in an optional step 204, determining parameter data indicative of one or more lighting parameters of the light effects. The step 210 of associating the light effects of the surplus intended light settings may be then performed further in dependence on the extracted parameter data.

Additionally, or alternatively, the methods 200a and 300 may include, in an optional step 206, ascertaining lighting device data indicative of respective operational capabilities of the target lighting devices. The step 210 of associating the light effects of the surplus intended light settings may be then performed further in dependence on the ascertained lighting device data.

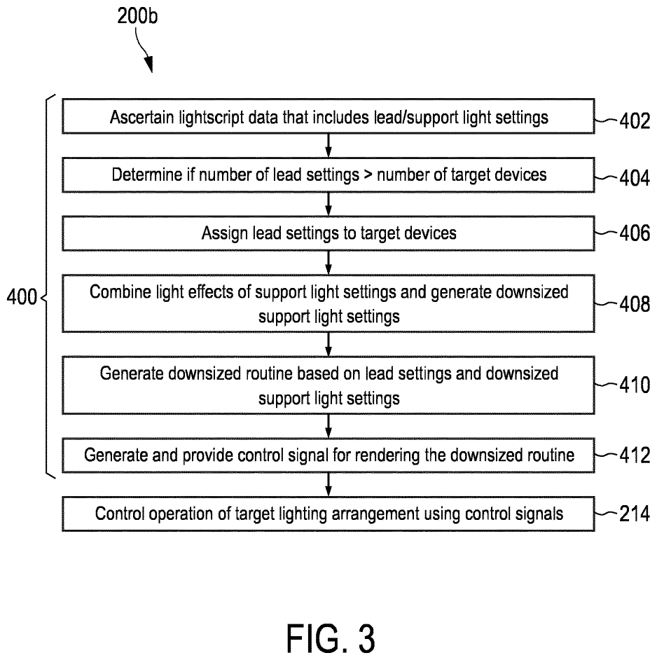

FIG. 3 shows a flow diagram of a computer implemented method 200b for controlling operation of a target lighting arrangement that includes a computer implemented method 400 for controlling operation of a controller device in accordance with another embodiment of the invention. The intended light settings included in the ascertained lightscript data (ascertained in step 402 of the methods 200b and 400) comprise leading light settings and support light settings. The methods further comprise, upon determining in a step 404, that the number of leading light settings is smaller than the number of target lighting devices, assigning, in a step 406, each leading light settings to a respective one of the target lighting devices, combining, in a step 408, the light effects of the support light settings according to a predetermined combination rule to generate downsized support light settings, generate, in a step 410, a downsized lighting-effect routine based on the lead light settings and the downsized support light settings, and generating and providing, in a step 410 control signals for controlling the target lighting devices in accordance with the leading light settings and the downsized support light settings for rendering the downsized lighting-effect routine on the target lighting arrangement. The method 200b then comprises, in a step 214, controlling the target lighting devices of the target lighting arrangement in accordance with the downsized lighting-effect routine.

In summary, the invention is directed to a control device for controlling target lighting devices for rendering a downsized lighting-effect routine intended to be rendered by a larger number of devices. A data ascertainment unit is configured to ascertain lightscript data indicative of a set of intended light settings comprising light effects. A processing unit is configured to select a number of surplus light settings, to distribute the light effects of the surplus light settings to the other intended light settings and generate a downsized set of light settings indicative thereof; and to generate and provide control signals for controlling the target lighting devices in accordance with the downsized set of light settings, and thereby improving the fidelity with respect to the intended routine.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. Control device for controlling one or more target lighting devices of a target lighting arrangement for rendering a downsized lighting-effect routine that corresponds to an intended lighting-effect routine intended to be rendered by at least a predetermined number of intended lighting devices that is higher than a number of target lighting devices of the target lighting arrangement, the control device comprising:
a data ascertainment unit configured to ascertain lightscript data indicative of a set of intended light settings, each intended light setting comprising one or more light effects associated to a respective intended lighting device, the set of intended light settings being indicative of the intended lighting-effect routine;
a processing unit connected to the data ascertainment unit and configured to:
select, in accordance with a predetermined selection algorithm, a number of surplus light settings that corresponds to a difference between the number of intended lighting devices for rendering the intended lighting-effect routine and the number of target lighting devices of the target lighting arrangement;
associate, in accordance with a predetermined association rule, the light effects of the selected surplus light settings to the light settings of those remaining intended light settings that are not surplus light settings and generate a downsized set of light settings indicative thereof; and
generate and provide control signals for controlling the target lighting devices in accordance with the downsized set of light settings for rendering the downsized lighting-effect routine on the target lighting arrangement.

2. The control device of claim 1, wherein the lightscript data comprises priority data indicative of a respective priority of the intended light settings of the set of intended light settings, and wherein the processing unit is configured to select the surplus light settings in dependence on the priority data.

3. The control device of claim 1, wherein the intended light settings included in the lightscript data comprise leading light settings and support light settings, and wherein, the processing unit is configured, upon determination that the number of leading light settings is smaller than the number of target lighting devices,
to assign each leading light settings to a respective one of the target lighting devices;
to combine the light effects of the support light settings according to a predetermined combination rule to generate downsized support light settings; and
to generate and provide control signals for controlling the target lighting devices in accordance with the leading light settings and the downsized support light settings for rendering the downsized lighting-effect routine on the target lighting arrangement.

4. The control device of claim 1, wherein processing unit is further configured to determine parameter data indicative of one or more lighting parameters of the light effects and to associate the light effects of the surplus intended light settings further in dependence on the extracted parameter data.

5. The control device of claim 4, wherein the lighting parameters for which parameter data is determined include one or more of color value, brightness value, beam-shape, angle value, orientation or position.

6. The control device of claim 1, wherein the data ascertainment unit is further configured to ascertain lighting device data indicative of respective operational capabilities of the target lighting devices, and wherein the processing unit is further configured to associate the light effects of the surplus intended light settings further in dependence on the ascertained lighting device data.

7. The control device of claim 1, wherein the data ascertainment unit is configured as a data input unit that is configured to receive the lightscript data via a wired or a wireless connection.

8. A target lighting arrangement for rendering a downsized lighting-effect routine, the lighting arrangement comprising;
one or more target lighting devices;
a control device in accordance with claim 1, for controlling the one or more target lighting devices for rendering a downsized lighting-effect routine that corresponds to an intended lighting-effect routine to intended to be rendered by at least a predetermined number of intended lighting devices that is higher than a number of target lighting devices of the target lighting arrangement.

9. Computer implemented method for controlling operation of a control device in accordance with claim 1, the method comprising:
ascertaining lightscript data indicative of a set of intended light settings each intended light setting comprising one or more light effects associated to a respective intended lighting device, the set of intended light settings being indicative of an intended lighting-effect routine;
selecting, in accordance with a predetermined selection algorithm, a number of surplus light settings, that corresponds to a difference between the number of intended lighting devices for rendering the intended lighting-effect routine and a number of target lighting devices of a target lighting arrangement;
associating, in accordance with a predetermined association rule, the light effects of the selected surplus light settings to the light settings those remaining intended light settings that are not surplus light settings and generating a downsized set of light settings indicative thereof; and
generating and providing control signals for controlling the target lighting devices in accordance with the downsized set of light settings for rendering the downsized lighting-effect routine on the target lighting arrangement.

10. The method of claim 9 wherein the step of selecting the surplus light settings in done in dependence on priority data comprised by the lightscript data.

11. The method of claim 9, further comprising determining parameter data indicative of one or more lighting parameters of the light effects and associating the light effects of the surplus intended light settings further in dependence on the extracted parameter data.

12. The method of claim 9, further comprising ascertaining lighting device data indicative of respective operational capabilities of the target lighting devices, and associating the light effects of the surplus intended light settings further in dependence on the ascertained lighting device data.

13. The method of claim 9, wherein the intended light settings included in the lightscript data comprise leading light settings and support light settings, the method further comprising, upon determining that the number of leading light settings is smaller than the number of target lighting devices,
assigning each leading light settings to a respective one of the target lighting devices;
combining the light effects of the support light settings according to a predetermined combination rule to generate downsized support light settings; and
generating and providing control signals for controlling the target lighting devices in accordance with the leading light settings and the downsized support light settings for rendering the downsized lighting-effect routine on the target lighting arrangement.

14. Computer implemented method for controlling operation of a target lighting arrangement, for rendering a downsized lighting-effect routine that corresponds to an intended lighting-effect routine to intended to be rendered by at least a predetermined number of intended lighting devices that is higher than a number of target lighting devices of the target lighting arrangement, the method comprising:
performing the method of claim 9; and
controlling the target lighting devices of the target lighting arrangement in accordance with the downsized lighting-effect routine.

15. A computer program product for a computing device, the computer program product comprising computer program code to perform the method of claim 9 when the computer program product is run on a processing unit of the computing device.
